(19) United States
(12) Patent Application Publication
(10) Pub. No.: US 2026/0029041 A1
(43) Pub. Date: Jan. 29, 2026

(54) COMPLIANT MECHANISM ACTUATED BELT-BASED CONTINUOUSLY VARIABLE TRANSMISSION

(71) Applicant: Transcend Mechanics LLC, Milford, CT (US)

(72) Inventor: Ethan John Wicko, Milford, CT (US)

(21) Appl. No.: 19/145,128

(22) PCT Filed: Jan. 4, 2024
(86) PCT No.: PCT/US2024/010294

§ 371 Date: Jul. 1, 2025

Related U.S. Application Data
(60) Provisional application No. 63/436,990, filed on Jan. 4, 2023.

(51) Int. Cl. F16H 9/18; F16H 9/24; F16H 57/035

(52) U.S. Cl. CPC F16H 9/18; F16H 9/24; F16H 57/035

(57) ABSTRACT

A continuously variable transmission includes a drive pulley mounted on a drive shaft, a driven pulley mounted on a driven shaft, a belt connects the drive pulley and the driven pulley, and a complaint mechanism actuation assembly. The pulleys each include a first pulley half axially fixed along the respective shaft and rotates as the respective shaft rotates, the first pulley half has a first conical shaped interior surface; and a second pulley half movable along the respective shaft and rotates as the respective shaft rotates, the second pulley half has a second conical shaped interior surface that faces the first conical shaped interior surface. The compliant mechanism assembly abuts one of the second pulley halves and moves the second pulley half axially along its respective shaft to adjust an axial distance between the pulley halves thereby adjusting an effective diameter of the belt around the pulley.

### CROSS REFERENCE TO RELATED APPLICATIONS

This application claims the priority benefit of U.S. Provisional Patent Application No. 63/436,990, filed Jan. 4, 2023, the contents of which is incorporated by reference as if disclosed herein in its entirety.

### FIELD

The present technology relates generally to device and vehicle transmissions, and more particularly, to continuously variable transmissions.

### BACKGROUND

Conventional continuously variable transmissions (“CVTs”) cannot be adapted for low-revolutions per minute (“RPM”), low-weight, and low-torque applications, such as a bicycle. Recent attempts to solve the problem use a “hypergear” that spins an internal mechanism to the RPM needed to actuate a belt-based CVT in a manner similar to that of an automotive CVT (i.e., centripetal force causing linear force along a shaft), or a continuously variable planetary gear (“CVP”) that behaves in a similar way to a CVT. However, these technologies are mechanically inefficient, heavy (relative to weights associated with bicycles), and limited in their gear ratio ranges.

Thus, a need exists for an improved CVT that addresses at least the problems described above.

### SUMMARY

According to an embodiment of the present technology, a continuously variable transmission (“CVT”) is provided. The CVT includes a housing having openings in opposing sides thereof for receiving a drive shaft and a driven shaft, a drive pulley positioned in the housing and mounted on the drive shaft, a driven pulley positioned in the housing and mounted on the drive shaft, a belt mounted on and connecting the drive pulley and the driven pulley, and a complaint mechanism assembly used for transmission actuation. Each of the drive pulley and the driven pulley includes a first pulley half that is axially fixed along the respective shaft and is configured to rotate as the respective shaft rotates, the first pulley half having a first conical shaped interior surface, and a second pulley half that is movable along the respective shaft and is configured to rotate as the respective shaft rotates, the second pulley half having a second conical shaped interior surface that faces the first conical shaped interior surface of the first pulley half. The compliant mechanism assembly abuts one of the second pulley halves and is configured to move the second pulley half axially along its respective shaft to adjust an axial distance between the second pulley half and its respective first pulley half thereby adjusting an effective diameter of the belt around the pulley.

In some embodiments, the CVT includes a spring that abuts the other of the second pulley halves. The spring is configured to move the second pulley half axially along its respective shaft in response to the compliant mechanism assembly moving the one of the second pulley halves to adjust an axial distance between the other second pulley half and its respective first pulley half thereby further adjusting the effective diameter of the belt.

In some embodiments, the compliant mechanism assembly abuts the one of the second pulley halves via a first thrust bearing and the spring abuts the other of the second pulley halves via a second thrust bearing.

In some embodiments, each second pulley half is connected to its respective shaft via a bushing. The bushing includes a cylindrical shape and a bore therein for receiving the respective shaft. The bore is defined by an inner circumferential surface having a cross-sectional profile that conforms to a cross-sectional profile of an exterior circumferential surface of the respective shaft. The bushing has a smooth exterior circumferential surface configured to be received in a central hole of the second pulley half such that the second pulley half is axially movable along the bushing.

In some embodiments, the cross-sectional profile of the exterior circumferential surface of each of the drive shaft and the driven shaft is splined.

In some embodiments, the compliant mechanism assembly includes a hollow frame having a plurality of rigid members, each rigid member is connected to its adjacent rigid members via flexure members, one of the rigid members has an elongated portion extending inwardly, the elongated portion has two extended holes therein; two motors in a stacked arrangement, each motor having a motor shaft connected to a threaded rod; a motor rotation-restraining plate secured to the two motors; and a threaded brass insert located in each of the two extended holes, the threaded brass inserts configured to receive the threaded rods of the motors such that actuation of the motors rotates the threaded rods within the threaded brass inserts thereby adjusting a distance between the one of the rigid members and an opposing one of the rigid members.

In some embodiments, at least one of the threaded rods has a rod adapter installed thereon.

In some embodiments, at least one of the extended holes has a variable diameter along its length to accommodate the threaded brass insert and the rod adapter.

In some embodiments, the CVT includes at least one hard stop attached to one of the rigid members, the hard stop extends inwardly toward an opposing rigid member and is configured to limit actuation of the compliant mechanism assembly.

In some embodiments, an opposing pair of the rigid members has holes therein for receiving one of the drive shaft or the driven shaft, one of the opposing pair of rigid members has a locking means therein for locking the compliant mechanism assembly to the housing and constraining rotation of the compliant mechanism assembly.

In some embodiments, the CVT includes a microcontroller configured to control actuation of the compliant mechanism assembly. In some embodiments, the control system software run by the microcontroller of the compliant mechanism assembly is controlled with sensors detecting rotation of the shaft. Other embodiments use additional data such as pedaling power, bicycle acceleration, and environmental data.

In some embodiments, the CVT includes at least one sensor configured to detect and communicate a rotational speed of the drive shaft to the microcontroller. In some embodiments, the at least one sensor is a Hall effect sensor. In some embodiments, strain gauges and accelerometers are used to gather data about pedaling power and bicycle acceleration respectively. In other embodiments, Lidar sensors (or similar sensors) are used to gather environmental data.

In some embodiments, the belt includes a flexible loop that has an upper surface and a bottom surface, at least one flexible chording attached to the bottom surface, and at least one rolling element attached to the at least one flexible chording. The at least one flexible chording is substantially aligned with a circumference of the flexible loop and spans the circumference of the flexible loop. The at least one rolling element is configured to engage the drive pulley and the driven pulley and rotate about the at least one flexible chording to axially slide the belt along the drive pulley and the driven pulley.

In some embodiments, the at least one flexible chording includes two flexible chording spanning the circumference of the flexible loop substantially parallel to each other, and the at least one rolling element includes a plurality of rolling elements attached to each of the two flexible chordings.

In some embodiments, the flexible loop includes a plurality of rigid anti-shear plates connected end-to-end. Each of the plurality of rigid anti-shear plates includes a first end having a tab extending therefrom; a second end having a notch extending therein, the notch corresponds to the tab such that the first end of a first rigid anti-shear plate is configured to interlock with the second end of a second rigid anti-shear plate; an upper surface having a lip adjacent the second end, the lip is configured to retain the tab of an adjacent rigid anti-shear plate in the notch of the second end as the belt bends around the drive pulley and the driven pulley; and a bottom surface having a flange extending substantially perpendicular therefrom, the flange having at least one hole for retaining the at least one flexible chording.

In some embodiments, the flexible loop includes a flexible anti-shear ring having an upper surface, a bottom surface, and a plurality of grooves in the bottom surface extending toward the upper surface thereby forming a plurality of flat segments; and a plurality of rigid plates. Each of the plurality of rigid plates is connected to a respective one of the plurality of flat segments of the flexible anti-shear ring and extends substantially perpendicular from the bottom surface. Each of the plurality of rigid plates having at least one hole for retaining the at least one flexible chording.

According to another embodiment of the present technology, a belt for a continuously variable transmission is provided. The belt includes a flexible loop that has an upper surface and a bottom surface. At least two flexible chordings are attached to the bottom surface of the flexible loop and are substantially aligned with a circumference of the flexible loop and span the circumference of the flexible loop. A plurality of rolling elements are attached to each of the flexible chordings and are configured to engage a drive pulley and a driven pulley of the continuously variable transmission and rotate about the respective flexible chording to axially slide the belt along at least one of the drive pulley and the driven pulley.

In some embodiments, the flexible loop includes a plurality of rigid anti-shear plates connected end-to-end. Each of the plurality of rigid anti-shear plates includes a first end having a tab extending therefrom; a second end having a notch extending therein, the notch corresponds to the tab such that the first end of a first rigid anti-shear plate is configured to interlock with the second end of a second rigid anti-shear plate; an upper surface having a lip adjacent the second end, the lip is configured to retain the tab of an adjacent rigid anti-shear plate in the notch of the second end as the belt bends around the drive pulley and the driven pulley; and a bottom surface having a flange extending substantially perpendicular therefrom, the flange having at least two holes for retaining the at least two flexible chordings.

In some embodiments, the flexible loop includes a flexible anti-shear ring having an upper surface, a bottom surface, and a plurality of grooves in the bottom surface extending toward the upper surface thereby forming a plurality of flat segments; and a plurality of rigid plates. Each of the plurality of rigid plates is connected to a respective one of the plurality of flat segments of the flexible anti-shear ring and extends substantially perpendicular from the bottom surface. Each of the plurality of rigid plates having at least two holes for retaining the at least two flexible chordings.

According to yet another embodiment of the present technology, a continuously variable transmission (“CVT”) is provided. The CVT includes a housing having openings in opposing sides thereof for receiving a drive shaft and a driven shaft, a drive pulley positioned in the housing and mounted on the drive shaft, a driven pulley positioned in the housing and mounted on the driven shaft, and a belt mounted on and connecting the drive pulley and the driven pulley. The belt includes a flexible loop having an upper surface and a bottom surface; at least two flexible chordings attached to the bottom surface of the flexible loop, the at least two flexible chordings being substantially aligned with a circumference of the flexible loop and spanning the circumference of the flexible loop; and a plurality of rolling elements attached to each of the at least two flexible chordings. The plurality of rolling elements configured to engage a drive pulley and a driven pulley of the continuously variable transmission and rotate about the respective flexible chording thereby axially sliding the belt along at least one of the drive pulley and the driven pulley. Each of the drive pulley and the driven pulley includes a first pulley half that is axially fixed along the respective shaft and is configured to rotate as the respective shaft rotates, the first pulley half having a first conical shaped interior surface; and a second pulley half that is movable along the respective shaft and is configured to rotate as the respective shaft rotates, the second pulley half having a second conical shaped interior surface that faces the first conical shaped interior surface of the first pulley half. The CVT includes a compliant mechanism assembly abutting one of the second pulley halves, the compliant mechanism assembly is configured to move the second pulley half axially along its respective shaft to adjust an axial distance between the second pulley half and its respective first pulley half thereby adjusting an effective diameter of the belt; and a spring abutting the other of the second pulley halves, the spring is configured to move the second pulley half axially along its respective shaft in response to the compliant mechanism assembly moving the one of the second pulley halves to adjust an axial distance between the other second pulley half and its respective first pulley half thereby further adjusting the effective diameter of the belt.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1A is an isometric view of a continuously variable transmission (“CVT”) according to some embodiments of the present technology.

FIG. 1B is a plan view of the CVT of FIG. 1A.

FIG. 1C is a rear view of the CVT of FIG. 1A.

FIG. 2 is an isometric view of a bushing used in some embodiments of the CVT.

FIG. 3A is a side view of a movable pulley half used in some embodiments of the CVT.

FIG. 3B is an isometric view of the movable pulley half of FIG. 3A.

FIG. 4A is a side view of a fixed pulley half used in some embodiments of the CVT.

FIG. 4B is an isometric view of the fixed pulley half of FIG. 4A.

FIG. 5A is an isometric partially exploded view of a compliant mechanism actuation assembly according to some embodiments of the present technology.

FIG. 5B is a side partially exploded view of the compliant mechanism actuation assembly of FIG. 5A.

FIG. 6A is an isometric view of a compliant mechanism according to some embodiments of the present technology.

FIG. 6B is a side view of the compliant mechanism of FIG. 6A.

FIG. 6C is an isometric view of a compliant mechanism according to some embodiments of the present technology.

FIG. 7A is a bottom isometric view of a portion of a belt according to some embodiments of the present technology.

FIG. 7B is a bottom plan view of the belt portion of FIG. 7A.

FIG. 7C is a top isometric view of the belt portion of FIG. 7A.

FIG. 7D is a top plan view of the belt portion of FIG. 7A.

FIG. 8A is a side view of a portion of a belt according to some embodiments of the present technology.

FIG. 8B is a bottom plan view of the belt portion of FIG. 8A.

FIG. 8C is a bottom isometric view of the belt portion of FIG. 8A.

FIG. 9A is an isometric view of a rolling element of a belt having an interface surface thereon according to some embodiments of the present technology.

FIG. 9B is a front view of the rolling element of FIG. 9A.

FIG. 9C is an isometric view of two rolling elements of FIG. 9A interlocking via the respective interface surfaces.

FIG. 9D is a front view of the rolling elements of FIG. 9C.

FIG. 10A is an isometric view of an interface surface for use on the pulleys of a CVT according to some embodiments of the present technology.

FIG. 10B is a side view of the interface surface of FIG. 10A.

### DETAILED DESCRIPTION

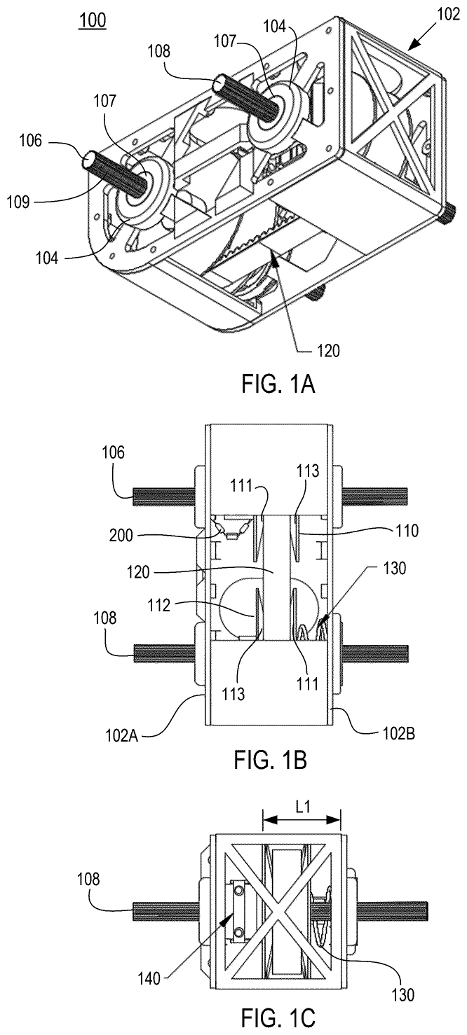

As shown in FIGS. 1A-1C, a continuously variable transmission (“CVT”) is generally designated by the numeral 100. CVT 100 includes a housing 102 that has openings 104 in opposing sides 102A, 102B of the housing 102 for receiving a drive shaft 106 and a driven shaft 108 therein. In some embodiments, the shafts 106, 108 each have one rotational degree of freedom and are supported by ball bearings 107. The shafts 106, 108 each have a splined exterior circumferential surface 109. The CVT shown in the drawing figures is configured for use on a bicycle, but the present technology is not limited thereto and contemplates embodiments where the CVT is configured for other devices and vehicles, such as electronic bicycles, training bicycles, exercise bicycles, cars, motorcycles, all-terrain vehicles, snowmobiles, etc., or any other transmission-based device. A user pedals onto the drive shaft 106, and the power exiting the CVT 100 is transmitted to the rear wheel via a belt drive or chain drive via the driven shaft 108. In some embodiments, housing 102 replaces a section of a bicycle frame where the bottom bracket is. Housing 102 is a structural component that also provides protection for the inside of the CVT 100 from environmental contaminants with its enclosed nature.

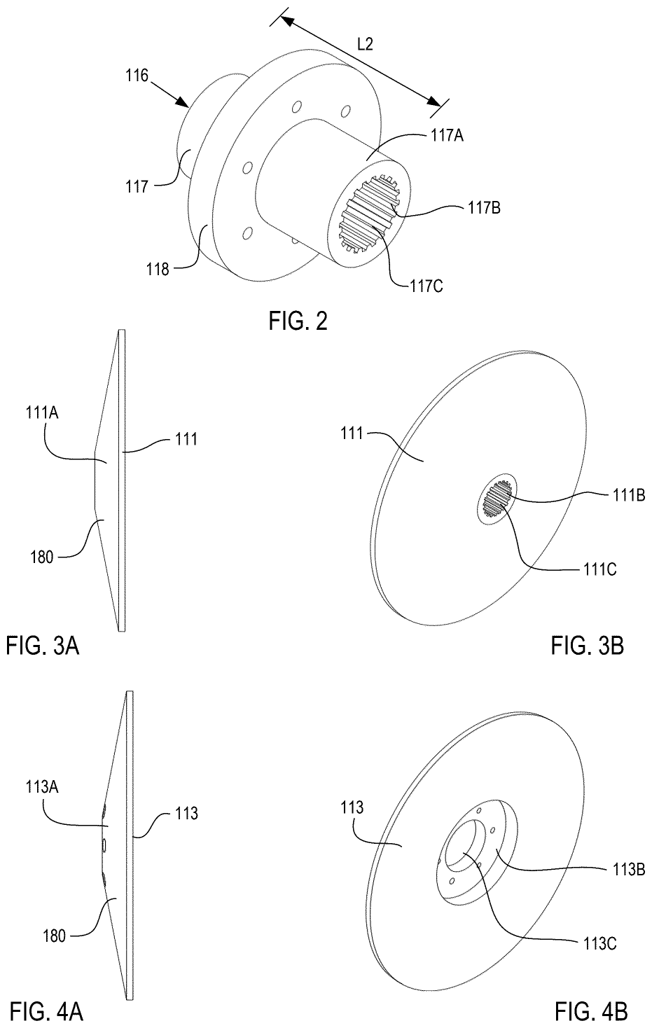

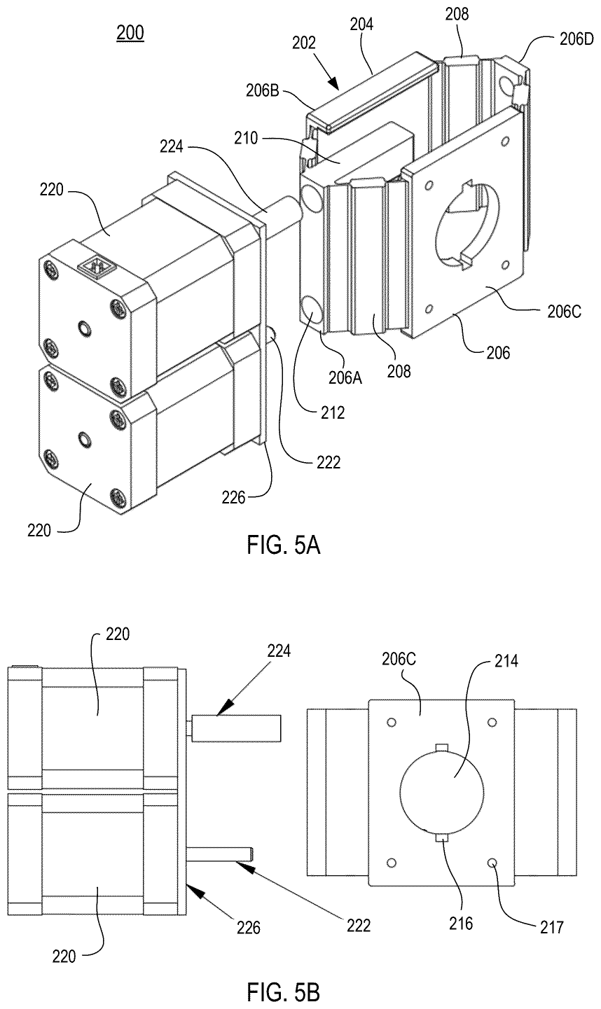

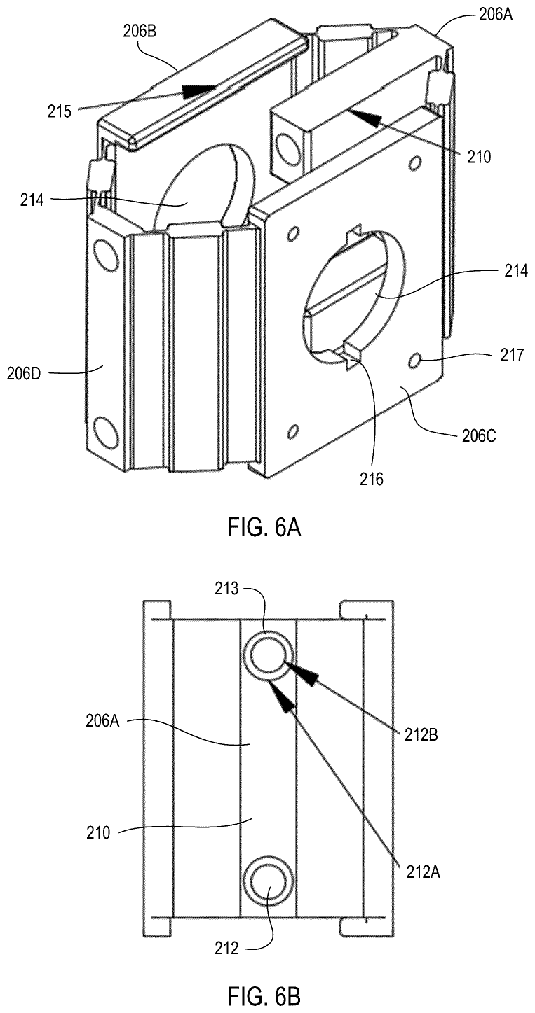

A drive pulley 110 is positioned in the housing 102 and is mounted on the drive shaft 106. A driven pulley 112 is positioned in the housing 102 and is mounted on the driven shaft 108. A belt 120 is mounted on and connecting the drive pulley 110 and the driven pulley 112. Each of the drive pulley 110 and the driven pulley 112 includes a fixed pulley half 111 that is axially fixed along the length L1 of the respective shaft 106, 108 (i.e., fixed pulley half 111 does not move axially along the shaft 106, 108) and is configured to rotate as the shaft 106, 108 rotates. The fixed pulley half 111 has a conical shaped interior surface 111A, as shown in FIG. 3A. The fixed pulley half 111 has a bore 111B defined by a splined interior circumferential surface 111C that is configured to receive the shaft 106, 108, as shown in FIG. 3B. Each of the drive pulley 110 and the driven pulley 112 includes a movable pulley half 113 that is movable along the length L1 of the respective shaft 106, 108 and is configured to rotate as the shaft 106, 108 rotates. The movable pulley half 113 has a conical shaped interior surface 113A, as shown in FIG. 4A, that faces the conical shaped interior surface 111A of the fixed pulley half 111, as shown in FIG. 1B. As shown in FIG. 4B, the movable pulley half 113 has a recessed base 113B and a bore 113C centrally located therein, as shown in FIG. 4B. In some embodiments, the axial movement of the movable pulley half 113 occurs due to a bushing 116, as shown in FIG. 2. Bushing 116 has a cylindrical body 117 having a length L2 with a smooth exterior circumferential surface 117A and a splined interior circumferential surface 117B defining a bore 117C that is configured to receive the shaft 106, 108. The cylindrical body 117 is configured to be received in the bore 113C of the movable pulley half 113 such that the movable pulley half 113 is axially movable along the length L2 of the cylindrical body 117. In some embodiments, bushing 116 has a circumferential flange 118 on the cylindrical body 117 that is configured to move along the length L2 and engages the recessed base 113B of the movable pulley half 113. In some embodiments, the bushing 116 is formed of a plastic material, a composite material, a self-lubricating plastic material, a metal with a low coefficient of friction, or combinations thereof. In some embodiments, the conical shaped interior surface 111A of the fixed pulley half 111 and the conical shaped interior surface 113A of the movable pulley half 113 each have an interface surface 180 thereon. The interface surface 180 is configured to engage with an interface surface 170 of a rolling element 124 of the belt 120, as discussed in more detail below.

The CVT 100 includes a compliant mechanism actuation assembly 200 that abuts one of the movable pulley halves 113, as shown in FIG. 1B. The compliant mechanism actuation assembly 200 is configured to move the movable pulley half 113 axially along its respective shaft 106, 108 to adjust an axial distance between the movable pulley half 113 and the fixed pulley half 111 of its respective pulley 110, 112, thereby adjusting an effective diameter of the belt 120 by adjusting the placement of the belt 120 along the conical shaped interior surfaces 111A, 113A of the pulley 110, 112. In some embodiments, the compliant mechanism actuation assembly 200 abuts the drive pulley 110. In some embodiments, the compliant mechanism actuation assembly 200 abuts the driven pulley 112. In some embodiments, the CVT 100 includes a spring 130 that abuts the other one of the movable pulley halves 113 (i.e., the movable pulley half 113 that does not abut the compliant mechanism actuation assembly 200), as shown in FIG. 1B. The spring 130 is configured to move its respective movable pulley half 113 axially along its respective shaft 106, 108 in response to the compliant mechanism actuation assembly 200 moving its respective movable pulley half 113 to adjust an axial distance between the spring's 130 respective movable pulley half 113 and fixed pulley half 111, thereby further adjusting the effective diameter of the belt 120 by adjusting the placement of the belt 120 along the conical shaped interior surfaces 111A, 113A of the pulley 110, 112. In some embodiments, the spring 130 abuts the drive pulley 110. In some embodiments, the spring 130 abuts the driven pulley 112. In some embodiments, the compliant mechanism actuation assembly 200 and the spring 130 each abut their respective movable pulley halves 113 via a thrust bearing 140, as shown in FIG. 1C. In some embodiments, the complaint mechanism actuation assembly 200 is configured to apply a variable force. Since there is always a reaction force in the preloaded spring 130, this variable force is able to vary the location of both movable pulley halves 113 axially along the shaft 106, 108. As the movable pulley halves 113 move, the space between the pulley halves 111, 113 changes, thus the effective diameter of the belt 120 as it wraps around the pulley halves 111, 113 changes, changing the mechanical advantage of CVT 100.

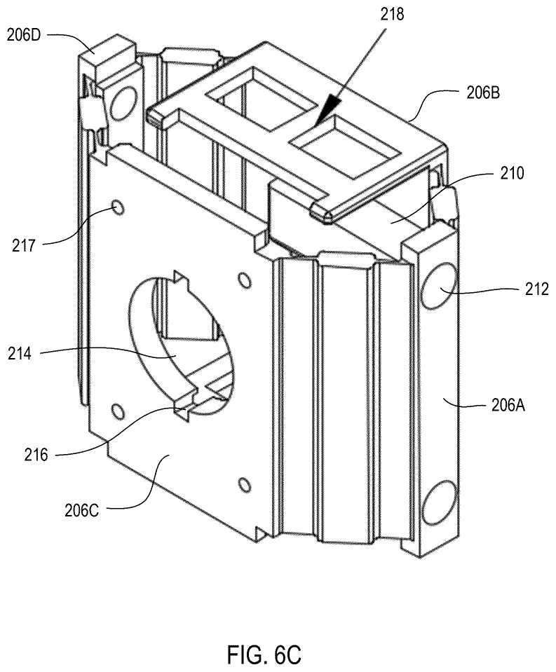

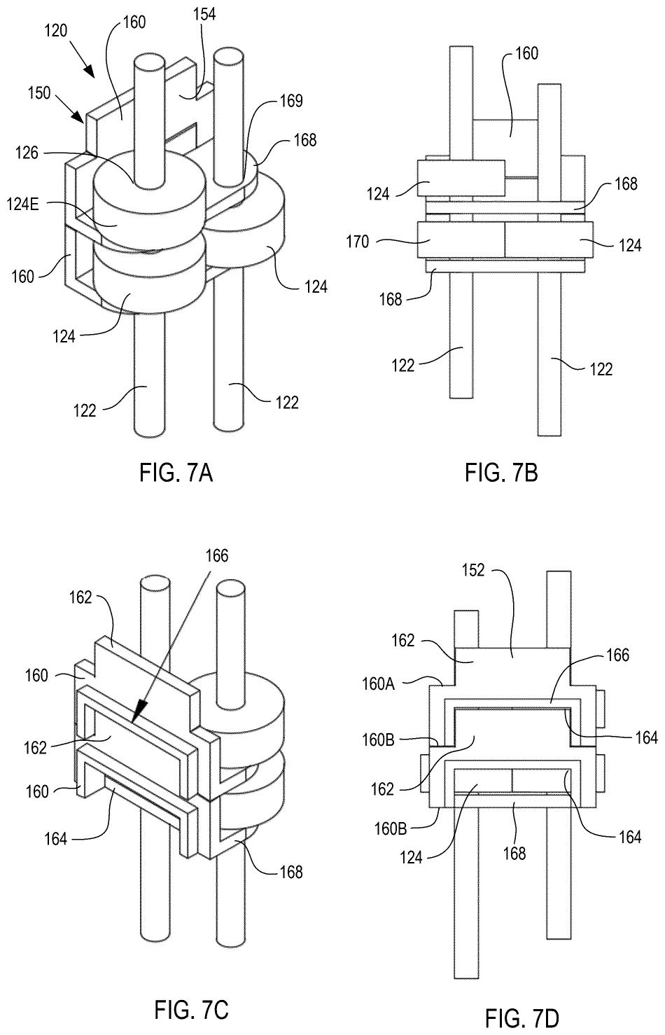

In some embodiments, the compliant mechanism actuation assembly 200 includes a compliant mechanism 202 having a hollow frame 204, as shown in FIGS. 5A-6C. Hollow frame 204 includes a plurality of rigid members 206, each of which are connected to its adjacent rigid members 206 via flexure members 208. One of the rigid members 206A includes an elongated portion 210 that extends inwardly into the hollow frame 204. The elongated portion 210 has two extended holes 212 therein. Two opposing rigid members 206B, 206C each have a bore 214 therein for receiving one of the shafts 106, 108. In some embodiments, one of the rigid members 206B includes tabs 215 on the top and bottom thereof to increase rigidity on the side of the hollow frame 204 that abuts the movable pulley half 113. In some embodiments, one of the bores 214 includes slots 216 for receiving corresponding pegs of an interior wall of the housing 102 (i.e., the slots 216 and corresponding pegs for a locking means) for locking the compliant mechanism actuation assembly 200 to the housing 102 and constraining rotation of the compliant mechanism actuation assembly 200. In some embodiments, the locking means includes holes 217 in the rigid member 206C for receiving fasteners (e.g., screws, bolts, rivets, etc.) to secure the compliant mechanism actuation assembly 200 to the interior wall of housing 102. In some embodiments, at least one hard stop 218 is attached to a tab 215 on one of the rigid members 206B, as shown in FIG. 6C. The hard stop 218 extends inwardly toward an opposing rigid member 206C and is configured to limit actuation of the compliant mechanism actuation assembly 200. The hard stop 218 provides protection from a state of inversion of the mechanism, which can occur when the rigid segments 206 are forced inward (instead of naturally bowing outward). In some embodiments, the compliant mechanism 202 is constructed using fused deposition modeling (“FDM”) additive manufacturing and carbon fiber infused nylon filament or injection molding of a similar material to produce similar properties. The compliant mechanism actuation assembly 200 can be used for many additional applications outside the scope of a CVT where force needs to be applied between two points or planes in space.

As shown in FIGS. 5A-5B, the compliant mechanism actuation assembly 200 includes two motors 220 in a stacked arrangement. Each motor 220 has a motor shaft 222 connected to a threaded rod adapter 224. In some embodiments, one motor 220 has a motor shaft 222 without a threaded rod adapter 224, while the other motor 220 has a motor shaft 222 with the threaded rod adapter 224, as shown in FIG. 5B. The threaded rod adapters 224 are configured to be received in threaded inserts 213 that are threaded into the extended holes 212 of the compliant mechanism 202. In some embodiments, the threaded inserts 213 are threaded brass inserts configured for insertion into plastic materials. The extended holes 212 and the threaded inserts 213 are of a sufficient length to accommodate the lengths of the threaded rod adapter 224 and the motor shaft 222. By recessing the threaded inserts 213 in the compliant mechanism 202, the compliant mechanism actuation assembly 200 is made much more compact. In some embodiments, the extended holes 212 have a variable diameter along its length to accommodate the threaded insert 213 and the threaded rod adapter 224. In some embodiments, the extended holes 212 have a first diameter 212A that accommodates the threaded insert 213, and a second diameter 212B that accommodates the threaded rod adapter 224, as shown in FIG. 6B. Thus, actuation of the two motors 220 causes the motor shafts 222 and the threaded rod adapters 224 to rotate within the threaded inserts 213 of the extended holes 212, thereby adjusting the distances between rigid members 206A, 206B, 206C, and 206D.

The motors 220, when unrestrained, will rotate in reaction to the torque they are applying. Thus, in some embodiments a restraining plate 226 is attached to the motors 220 and used to lock the rotation of the motors 220 relative to one other. In some embodiments, the motors 220 are only attached to the restraining plate 226 and the threaded rod adapters 224 to allow for movement both parallel to the axis of the extended holes 213 and to the axis of the shaft 106, 108 as actuation occurs. In some embodiments, threaded rod adapters 224 are formed of a cylinder of aluminum, with threads matching the threads of the threaded inserts 213 on one end and a hole with an inner diameter equal to that of the motor shaft 222.

In some embodiments, actuation of the compliant mechanism actuation assembly 200 is controlled by software stored on a microcontroller to achieve a desired drive shaft 106 rotational speed for a user. This microcontroller is used to control electronics of the CVT 100 that allow for actuation such as motors/motor drivers and sensors that can be programmed to trigger when motors operate. In some embodiments, a Hall effect sensor is used to detect the drive shaft's 106 revolutions per minute (“RPM”). In some embodiments additional sensors, such as strain gauges, accelerometers, and lidar sensors, are used to determine the desired drive shaft 106 rotational speed based on data about pedaling power, bicycle acceleration, and environmental data. The control system software on the microcontroller determines when the RPM of the drive shaft 106 should be adjusted by increasing or decreasing the mechanical advantage of the CVT 100 via the compliant mechanism actuation assembly 200. In some embodiments, actuation of the motors 220 causes the threaded rod adapters 224 to spin and shorten the distance between the rigid segments 206A and 206D. Since the length of the flexure and rigid segments does not change, this forces the opposing rigid segments 206B and 206C to separate. When one of these rigid segments is restrained, the other segment enacts a force proportional to the torque of the motors along the shaft axially. The proportionality can be found by taking into consideration the pitch of the threads and the difference in the rate of distance traveled by the rigid segments that have the rod going through them and the rigid segments that are abutting the housing and pulley half. This rate is always changing throughout actuation as the geometry of the compliant mechanism changes. The difference in rate of distance traveled by these two pairs of segments and the thread pitch creates a mechanical advantage that can be calculated and changes in magnitude throughout actuation.

In some embodiments, a compression spring is placed between rigid segments 206B and 206C, resulting in a greater maximum force applied by the compliant mechanism actuation assembly 200. In some embodiments, the spring 130 and the compliant mechanism actuation assembly 200 are positioned on the same side of the CVT 100, resulting in reduced width of the CVT 100. In some embodiments, the movable pulley halves 113 are each positioned on the same side of the CVT 100. In some embodiments, the compliant mechanism actuation assembly 200 includes means of restricting undesired rotation or movement of the rigid segments 206 via additional flexure members 208 or slots 216. In some embodiments, the compliant mechanism 202 is functionally inverted to rely on compression from the rods 224 attached to motors 220 to actuate it instead of tension (like the embodiments shown in the drawing figures). In such embodiments, instead of being angled/bowed outwards the rigid segments 206 are angled/bowed inward and produce a less stable (without any other supports) but quite functional mechanism with a different occupied volume. In some embodiments, the compliant mechanism actuation assembly 200 is controlled via a cable strung between two pulleys positioned on the rigid members 206A and 206D. The cable pulleys are aligned in different configurations to change the magnitude and direction of the force applied to the rigid members 206. Mechanical advantage can be designed for by changing the diameter of the pulleys or adding external pulleys. The cable is pulled to provide a tension force with a grip shifter, a thumb/finger throttle, a motor, etc., or combinations thereof. In some embodiments, actuation of the CVT 100 uses a rack and pinion system where a rack gear is placed on a movable sleeve on the transmission shaft and a pinion gear moves that sleeve axially along the transmission shaft. When controlled by a motor or a cable routed elsewhere, the sleeve puts axial force on the movable pulley half via a thrust bearing between the sleeve surface and the pulley half non-conical face. In some embodiments, the sleeve is guided by a mechanism such as a mount attached elsewhere interfacing via linear bearings to allow axial sliding.

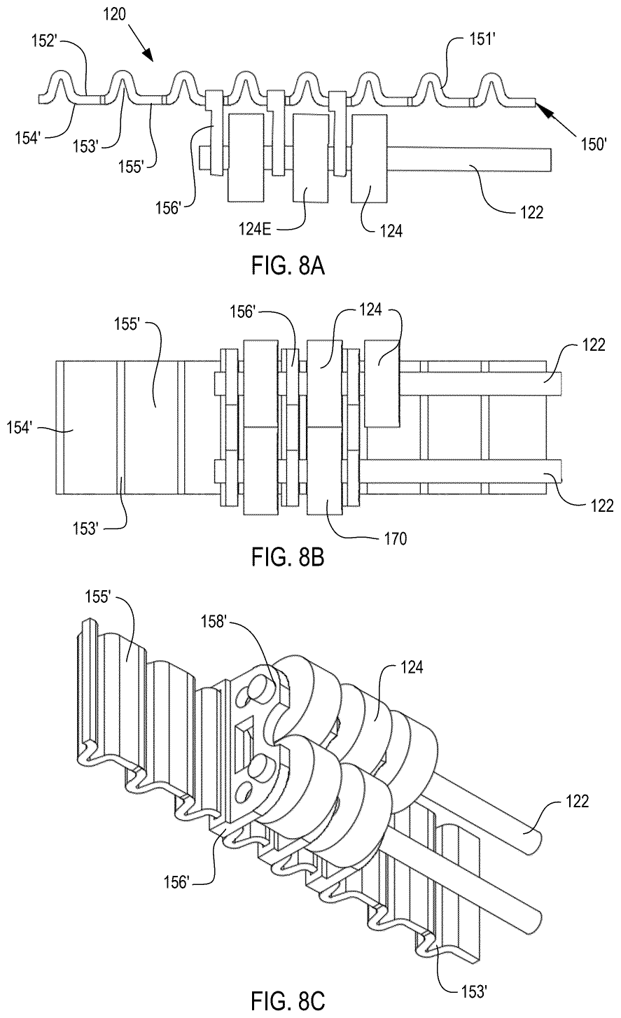

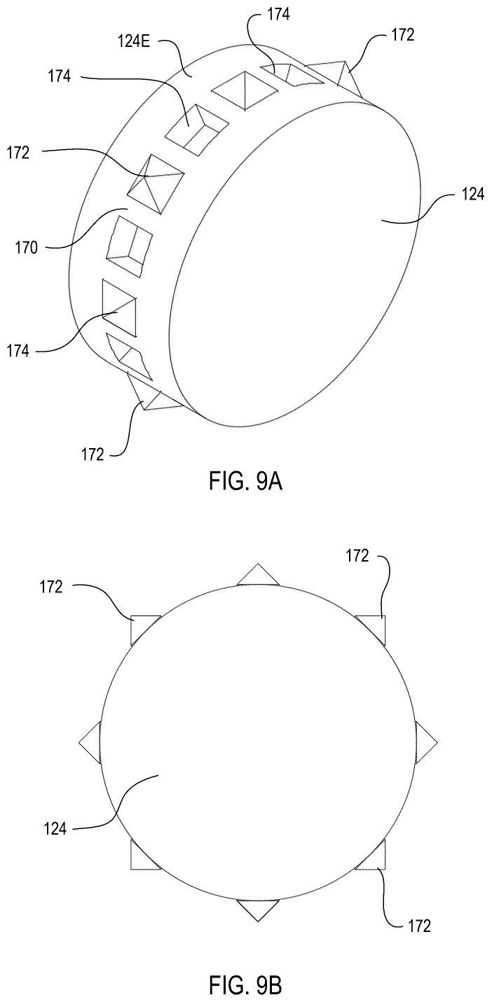

As shown in FIGS. 7A-8C, the belt 120 includes a flexible loop 150 that has an upper surface 152 and a bottom surface 154. At least one flexible chording 122 is attached to the bottom surface 154 of the flexible loop 150. In some embodiments, at least two flexible chordings 122 are attached to the bottom surface 154 of the flexible loop 150. The flexible chordings 122 span the circumference of the flexible loop 150 and are substantially parallel to each other and aligned with the circumference of the flexible loop 150. In some embodiments, the flexible chordings 122 are formed of a nylon material. A plurality of rolling elements 124 are attached to each of the flexible chordings 122. Each rolling element 124 includes a central bore 126 for receiving the flexible chording 122. Each rolling element 124 has an exterior circumferential surface 124E that is configured to engage the drive pulley 110 and the driven pulley 112 and rotate about the flexible chording 122 to axially slide/move the belt 120 along the drive pulley 110 and/or the driven pulley 112. In some embodiments, the exterior circumferential surface 124E has an interface surface 170 thereon. The interface surface 170 is configured to engage with an interface surface 180 of the conical shaped interior surface 111A of the fixed pulley half 111 and the conical shaped interior surface 113A of the movable pulley half 113, as discussed in more detail below. Although the embodiments shown in the drawing figures show a portion of the belt 120, the present technology contemplates that the flexible loop 150, flexible chordings 122, and the arrangement of rolling elements 124 continue such that the belt 120 forms a closed loop.

FIGS. 7A-7D show the belt 120 having a flexible loop 150 according to some embodiments of the present technology. The flexible loop 150 includes a plurality of rigid anti-shear plates 160 connected in an end-to-end fashion. Each rigid anti-shear plate 160 includes a first end 160A that has a tab 162 extending outwardly therefrom, and a second end 160B that has a notch 164 extending inwardly therein. The notch 164 corresponds to the tab 162 such that the first end 160A of a first rigid anti-shear plate 160 is configured to interlock with the second end 160B of a second, adjacent rigid anti-shear plate 160. The upper surface 152 of the flexible loop 150 has a lip 166 positioned adjacent the second end 160B of each rigid anti-shear plate 160. The lip 166 is configured to engage the tab 162 of an adjacent rigid anti-shear plate 160 to retain the tab 162 in the notch 164 as the belt 120 bends around the drive pulley 110 and the driven pulley 112. The bottom surface 154 of the flexible loop 150 has a flange 168 that extends downward substantially perpendicular from the second end 160B of each rigid anti-shear plate 160. The flange 168 has holes 169 for receiving the flexible chordings 122. In some embodiments, the rigid anti-shear plates 160 are formed of a rigid plastic material, a rigid metal material, etc. In some embodiments, each rigid anti-shear plate 160 secures at least one rolling element 124. In some embodiments, the rolling elements 124 are spaced apart to form a pattern such that not every rigid anti-shear plate 160 secures a rolling element 124. The spacing between the rolling elements 124 and the number of rolling elements 124 per rigid anti-shear plate 160 is adjustable depending on the receiving surface of the drive pulley 110 and the driven pulley 112.

FIGS. 8A-8C show the belt 120 having a flexible loop 150′ according to some embodiments of the present technology. The flexible loop 150′ includes a flexible anti-shear ring 151′ that has an upper surface 152′, a bottom surface 154′, and a plurality of grooves 153′ in the bottom surface 154′ that each extend upward toward the upper surface 152′ thereby forming a plurality of flat segments 155′. Each of the flat segments 155′ has a rigid plate 156′ attached to and extending downward substantially perpendicular from the bottom surface 154′. Each of the rigid plates 156′ has holes 158′ for receiving the flexible chordings 122. In some embodiments, the flexible anti-shear ring 151′ is formed of a thermoplastic polyurethane material, a rubber material, etc. In some embodiments, each flat segment 155′ secures at least one rolling element 124. In some embodiments, the rolling elements 124 are spaced apart to form a pattern such that not every flat segment 155′ secures a rolling element 124. The spacing between the rolling elements 124 and the number of rolling elements 124 per flat segment 155′ is adjustable depending on the receiving surface of the drive pulley 110 and the driven pulley 112.

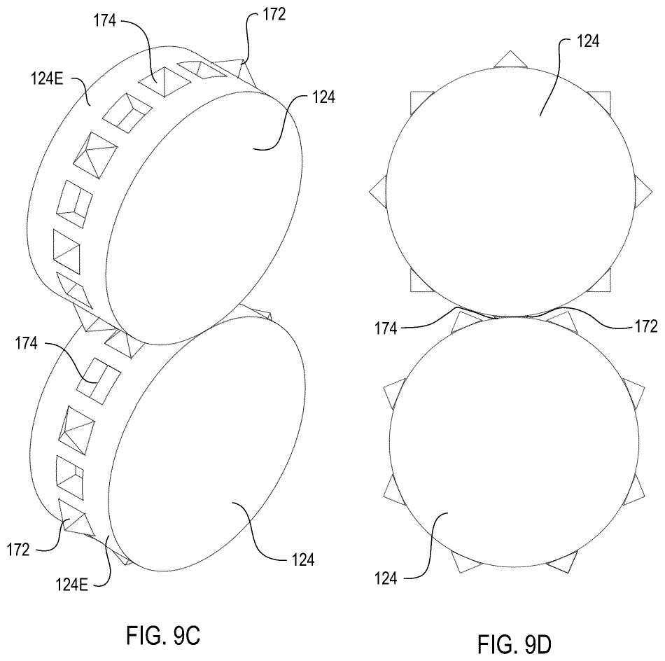

FIGS. 9A-9D show the rolling element 124 having an interface surface 170 on the exterior circumferential surface 124E according to some embodiments of the present technology. In some embodiments, the interface surface 170 is a frictional surface, defined herein as having a frictional coefficient of less than one. In some embodiments, the frictional surface is formed of a rubber material, a metal material, a textured material (e.g., etched aluminum, plastic, steel, rubber, etc.), a plastic material, a sandpaper material, etc., or combinations thereof. In some embodiments, the interface surface 170 is a pseudo mechanical surface, defined herein as having a frictional coefficient of greater than or equal to one. FIGS. 9A-9D show an example pseudo mechanical interface surface 170 that has a plurality of grooves 172 and a plurality of teeth 174 arranged in a pattern around the circumferential exterior surface 124E of the rolling element 124. In some embodiments, the grooves 172 and teeth 174 are arranged in a repeating pattern of one tooth 174 followed by three grooves 172, as shown in FIG. 9A. However, the present technology is not limited thereto and contemplates embodiments where the grooves 172 and teeth 174 are arranged in any suitable pattern, such as an alternating pattern, a repeating pattern of one tooth 174 followed by two grooves 172, etc. The teeth 174 correspond to the grooves 172 such that the teeth 174 of a first rolling element 124 are configured to engage and interlock with the grooves 172 of an adjacent rolling element 124 to ensure that the rolling elements 124 roll smoothly, as shown in FIGS. 9C-9D. The teeth 174 are also configured to engage and interlock with flexures 182 of interface surface 180 of the conical shaped interior surface 111A of the fixed pulley half 111 and the conical shaped interior surface 113A of the movable pulley half 113, as discussed in more detail below, to ensure that the rolling elements 124 slide/move/translate axially along the drive pulley 110 and driven pulley 112 (e.g., parallel to the length L1 of the shafts 106, 108) while preventing movement/translation of the rolling elements 124 in a direction transverse to the axial movement (e.g., perpendicular to the length L1 of the shafts 106, 108). Although the interface surface 170 shown in the drawing figures has grooves 172 and teeth 174, the present technology is not limited thereto and contemplates the interface surface 170 having any suitable combination of positive features, such as ratchets, teeth, cones, spikes, etc., and negative features, such as dimples, grooves, depressions, etc. that are configured to engage each other and interface surface 180.

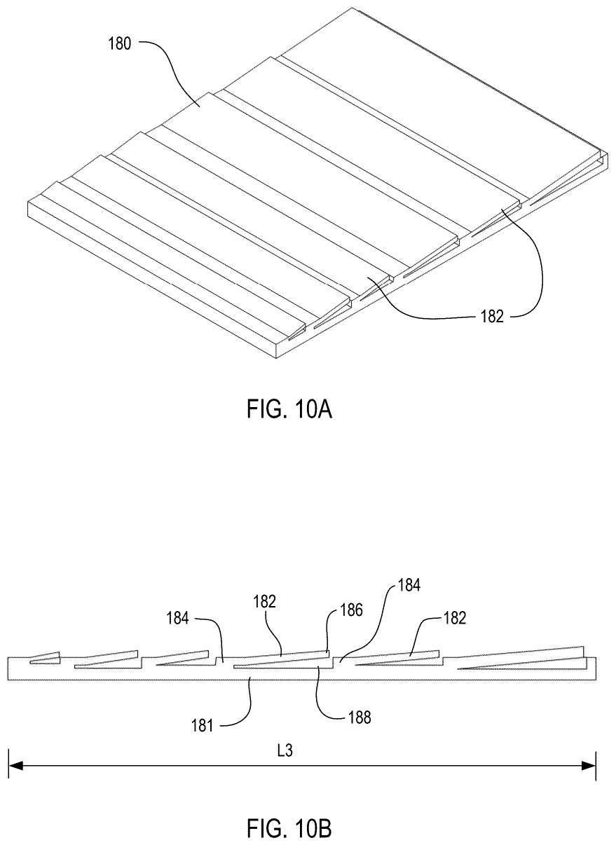

FIGS. 10A-10B show interface surface 180 of the conical shaped interior surface 111A of the fixed pulley half 111 and the conical shaped interior surface 113A of the movable pulley half 113 according to some embodiments of the present technology. In some embodiments, the interface surface 180 is a frictional surface, defined herein as having a frictional coefficient of less than one. In some embodiments, the frictional surface is formed of a rubber material, a metal material, a textured material (e.g., etched aluminum, plastic, steel, rubber, etc.), a plastic material, a sandpaper material, etc., or combinations thereof. In some embodiments, the interface surface 180 is a pseudo mechanical surface, defined herein as having a frictional coefficient of greater than or equal to one. FIGS. 10A-10B show an example pseudo mechanical interface surface 180 that has a base 181 with a plurality of flexures 182 thereon. Each flexure 182 has a first end 184 that is fixed to the base 181 and a second end 186 that is free of the base 181 and is angled upward away from the 181. The flexures 182 are arranged in an end-to-end fashion along a length L3 of the flexure 182 such that the second end 186 of a first flexure 182 is proximate to and, in some embodiments, slight above the first end 184 of an adjacent flexure 182, thereby forming a gap 188 between the adjacent flexures 182, as shown in FIG. 10B. The flexures 182 are configured to engage and interlock with the teeth 174 of interface 170 of the rolling elements 124 to ensure that the rolling elements 124 slide/move/translate axially along the drive pulley 110 and driven pulley 112 (e.g., parallel to the length L1 of the shafts 106, 108) while preventing movement/translation of the rolling elements 124 in a direction transverse to the axial movement (e.g., perpendicular to the length L1 of the shafts 106, 108). In some embodiments, the second ends 186 of the flexures 182 are configured to spring up to prevent non-axial translation of the rolling elements 124 and to recede into the gap 188 to assist axially translation of the rolling elements 124. In some embodiments, the plurality of flexures 182 have different dimensions (i.e., are not uniformly sized), as shown in FIGS. 10A-10B. In some embodiments, interface surface 180 is positioned such that the flexures 182 are aligned radially on the conical shaped interior surface 111A of the fixed pulley half 111 and the conical shaped interior surface 113A of the movable pulley half 113. Such radial alignment is beneficial for “static shifting” where the pulleys 110, 112 and shafts 106, 108 are not rotating but the CVT 100 is actuating via an applied axial force to one of the movable pulley halves 113. This is due to the change of the effective diameter of belt 120 that contacts the pulleys 110, 112 at different gear ratios. As the effective diameter changes, engagement of the interface surface 170 and interface surface 180 allows the length of belt 120 contacting the pulleys 110, 112 to increase or decrease by translating in the direction that is allowable (i.e., axial translation). When rotation starts again, the mechanical power transmitted to the shafts 106, 108 does not slip the belt 120 and pulleys 110, 112 relative to each other once again due to the directionality of the flexures 182. In some embodiments, interface surface 180 is positioned on the rolling elements 124 and interface surface 170 is positioned on the pulleys 110, 112.

Thus, in some embodiments, the belt 120 is a “roller-belt” that rolls along the pulleys 110, 112 axially. This has two benefits: friction force is anisotropic (only present in the circumferential direction) allowing shifting with high circumferential friction conditions and allowing static shifting to occur. Anisotropic friction force permits exceptional friction or physical engagement in both the circumferential and axial directions without hindering shifting/the belt moving along the pulleys. Due to this large friction in the circumferential direction with negligible friction in the radial direction, static shifting is possible. This means that it is possible to change the gear ratio even when the pulleys are not rotating, unlike traditional belt-based CVTs. Although the belt 120 shown in the drawing figures is configured for use in the CVT 100 discussed herein, the present technology is not limited thereto and contemplates the belt 120 being used in any other suitable type of CVT, such as CVTs configured for use in other devices and vehicles, such as electronic bicycles, training bicycles, exercise bicycles, cars, motorcycles, all-terrain vehicles, snowmobiles, etc., or any other transmission-based device.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology. The term “and/or” means any one of the items, any combination of the items, or all of the items with which this term is associated.

Each numerical or measured value in this specification is modified by the term “about.” The term “about” can refer to a variation of #5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

What is claimed is:

1. A continuously variable transmission comprising:
a housing having openings in opposing sides thereof for receiving a drive shaft and a driven shaft;
a drive pulley positioned in the housing and mounted on the drive shaft;
a driven pulley positioned in the housing and mounted on the driven shaft;
a belt mounted on and connecting the drive pulley and the driven pulley;
each of the drive pulley and the driven pulley comprising:
a first pulley half that is axially fixed along the respective shaft and is configured to rotate as the respective shaft rotates, the first pulley half having a first conical shaped interior surface; and
a second pulley half that is movable along the respective shaft and is configured to rotate as the respective shaft rotates, the second pulley half having a second conical shaped interior surface that faces the first conical shaped interior surface of the first pulley half; and
a compliant mechanism actuation assembly abutting one of the second pulley halves, the compliant mechanism actuation assembly is configured to move the second pulley half axially along its respective shaft to adjust an axial distance between the second pulley half and its respective first pulley half thereby adjusting an effective diameter of the belt.

2. The continuously variable transmission of claim 1, further comprising a spring abutting the other of the second pulley halves, the spring is configured to move the second pulley half axially along its respective shaft in response to the compliant mechanism assembly moving the one of the second pulley halves to adjust an axial distance between the other second pulley half and its respective first pulley half thereby further adjusting the effective diameter of the belt.

3. The continuously variable transmission of claim 2, wherein the compliant mechanism actuation assembly abuts the one of the second pulley halves via a first thrust bearing and the spring abuts the other of the second pulley halves via a second thrust bearing.

4. The continuously variable transmission of claim 1, wherein each second pulley half is connected to its respective shaft via a bushing, the bushing comprising a cylindrical shape and a bore therein for receiving the respective shaft, the bore defined by an inner circumferential surface having a cross-sectional profile that conforms to a cross-sectional profile of an exterior circumferential surface of the respective shaft, the bushing having a smooth exterior circumferential surface configured to be received in a central bore of the second pulley half such that the second pulley half is axially movable along the bushing.

5. The continuously variable transmission of claim of claim 4, wherein the cross-sectional profile of the exterior circumferential surface of each of the drive shaft and the driven shaft is splined.

6. The continuously variable transmission of claim 4, wherein the bushing further comprises a flange configured to limit axial movement of the second pulley half along the bushing.

7. The continuously variable transmission of claim 1, wherein the compliant mechanism actuation assembly comprises:
a hollow frame having a plurality of rigid members, each rigid member is connected to its adjacent rigid members via flexure members, one of the rigid members has an elongated portion extending inwardly, the elongated portion has two extended holes therein;
two motors in a stacked arrangement, each motor having a motor shaft connected to a threaded rod;
a motor rotation-restraining plate secured to the two motors; and
a threaded insert located in each of the two extended holes, the threaded inserts configured to receive the threaded rods of the motors such that actuation of the motors rotates the threaded rods within the threaded inserts thereby adjusting a distance between the one of the rigid members and an opposing one of the rigid members.

8. The continuously variable transmission of claim 7, wherein at least one of the threaded rods has a rod adapter installed thereon.

9. The continuously variable transmission of claim 8, wherein at least one of the extended holes has a variable diameter along its length to accommodate the threaded insert and the rod adapter.

10. The continuously variable transmission of claim 7, further comprising at least one hard stop attached to one of the rigid members, the hard stop extends inwardly toward an opposing rigid member and is configured to limit actuation of the compliant mechanism assembly.

11. The continuously variable transmission of claim 7, wherein an opposing pair of the rigid members has bores therein for receiving one of the drive shaft or the driven shaft, one of the opposing pair of rigid members has a locking means therein for locking the compliant mechanism assembly to the housing and constraining rotation of the compliant mechanism assembly.

12. The continuously variable transmission of claim 1, wherein the belt comprises:
a flexible loop having an upper surface and a bottom surface;
at least one flexible chording attached to the bottom surface of the flexible loop, the at least one flexible chording being substantially aligned with a circumference of the flexible loop and spanning the circumference of the flexible loop; and
at least one rolling element attached to the at least one flexible chording, the at least one rolling element configured to engage the drive pulley and the driven pulley and rotate about the at least one flexible chording thereby axially sliding the belt along at least one of the drive pulley and the driven pulley.

13. The continuously variable transmission of claim 12, wherein the at least one flexible chording comprises two flexible chording spanning the circumference of the flexible loop substantially parallel to each other; and
wherein the at least one rolling element comprises a plurality of rolling elements attached to each of the two flexible chordings.

14. The continuously variable transmission of claim 12, wherein the flexible loop comprises a plurality of rigid anti-shear plates connected end-to-end, each of the plurality of rigid anti-shear plates comprising:
a first end having a tab extending therefrom;
a second end having a notch extending therein, the notch corresponds to the tab such that the first end of a first rigid anti-shear plate is configured to interlock with the second end of a second rigid anti-shear plate;
an upper surface having a lip adjacent the second end, the lip is configured to retain the tab of an adjacent rigid anti-shear plate in the notch of the second end as the belt bends around the drive pulley and the driven pulley; and
a bottom surface having a flange extending substantially perpendicular therefrom, the flange having at least one hole for retaining the at least one flexible chording.

15. The continuously variable transmission of claim 12, wherein the flexible loop comprises
a flexible anti-shear ring having an upper surface, a bottom surface, and a plurality of grooves in the bottom surface extending toward the upper surface thereby forming a plurality of flat segments; and
a plurality of rigid plates, each of the plurality of rigid plates is connected to a respective one of the plurality of flat segments of the flexible anti-shear ring and extends substantially perpendicular from the bottom surface, each of the plurality of rigid plates having at least one hole for retaining the at least one flexible chording.

16. A belt for a continuously variable transmission, the belt comprising:
a flexible loop having an upper surface and a bottom surface;
at least two flexible chordings attached to the bottom surface of the flexible loop, the at least two flexible chordings being substantially aligned with a circumference of the flexible loop and spanning the circumference of the flexible loop; and
a plurality of rolling elements attached to each of the at least two flexible chordings, the plurality of rolling elements configured to engage a drive pulley and a driven pulley of the continuously variable transmission and rotate about the respective flexible chording thereby axially sliding the belt along at least one of the drive pulley and the driven pulley.

17. The belt of claim 16, wherein the flexible loop comprises a plurality of rigid anti-shear plates connected end-to-end, each of the plurality of rigid anti-shear plates comprising:
a first end having a tab extending therefrom;
a second end having a notch extending therein, the notch corresponds to the tab such that the first end of a first rigid anti-shear plate is configured to interlock with the second end of a second rigid anti-shear plate;
an upper surface having a lip adjacent the second end, the lip is configured to retain the tab of an adjacent rigid anti-shear plate in the notch of the second end as the belt bends around the drive pulley and the driven pulley; and
a bottom surface having a flange extending substantially perpendicular therefrom, the flange having at least two holes for retaining the at least two flexible chordings.

18. The belt of claim 16, wherein the flexible loop comprises
a flexible anti-shear ring having an upper surface, a bottom surface, and a plurality of grooves in the bottom surface extending toward the upper surface thereby forming a plurality of flat segments; and
a plurality of rigid plates, each of the plurality of rigid plates is connected to a respective one of the plurality of flat segments of the flexible anti-shear ring and extends substantially perpendicular from the bottom surface, each of the plurality of rigid plates having at least two holes for retaining the at least two flexible chordings.

19. A continuously variable transmission comprising:
a housing having openings in opposing sides thereof for receiving a drive shaft and a driven shaft;
a drive pulley positioned in the housing and mounted on the drive shaft;
a driven pulley positioned in the housing and mounted on the driven shaft;
a belt mounted on and connecting the drive pulley and the driven pulley, the belt comprising:
a flexible loop having an upper surface and a bottom surface;
at least two flexible chordings attached to the bottom surface of the flexible loop, the at least two flexible chordings being substantially aligned with a circumference of the flexible loop and spanning the circumference of the flexible loop; and
a plurality of rolling elements attached to each of the at least two flexible chordings, the plurality of rolling elements configured to engage a drive pulley and a driven pulley of the continuously variable transmission and rotate about the respective flexible chording thereby axially sliding the belt along at least one of the drive pulley and the driven pulley;
each of the drive pulley and the driven pulley comprising:
a first pulley half that is axially fixed along the respective shaft and is configured to rotate as the respective shaft rotates, the first pulley half having a first conical shaped interior surface; and
a second pulley half that is movable along the respective shaft and is configured to rotate as the respective shaft rotates, the second pulley half having a second conical shaped interior surface that faces the first conical shaped interior surface of the first pulley half;
a compliant mechanism actuation assembly abutting one of the second pulley halves, the compliant mechanism actuation assembly is configured to move the second pulley half axially along its respective shaft to adjust an axial distance between the second pulley half and its respective first pulley half thereby adjusting an effective diameter of the belt; and
a spring abutting the other of the second pulley halves, the spring is configured to move the second pulley half axially along its respective shaft in response to the compliant mechanism assembly moving the one of the second pulley halves to adjust an axial distance between the other second pulley half and its respective first pulley half thereby further adjusting the effective diameter of the belt.

20. The continuously variable transmission of claim 19, wherein the compliant mechanism actuation assembly comprises:
a hollow frame having a plurality of rigid members, each rigid member is connected to its adjacent rigid members via flexure members, one of the rigid members has an elongated portion extending inwardly, the elongated portion has two extended holes therein;
two motors in a stacked arrangement, each motor having a motor shaft connected to a threaded rod;
a motor rotation-restraining plate secured to the two motors; and
a threaded insert located in each of the two extended holes, the threaded inserts configured to receive the threaded rods of the motors such that actuation of the motors rotates the threaded rods within the threaded inserts thereby adjusting a distance between the one of the rigid members and an opposing one of the rigid members.
